(19) United States
(12) Patent Application Publication
(10) Pub. No.: US 2006/0203332 A1
(43) Pub. Date: Sep. 14, 2006

(54) Lens sheet, rear projection screen, and method of manufacturing lens sheet

(75) Inventors: Hiroyuki Shimotsuma, Niigata-ken (JP); Makoto Soyama, Niigata (JP)

Correspondence Address: OSHA LIANG L.L.P., 1221 MCKINNEY STREET, SUITE 2800, HOUSTON, TX, 77010, US

(73) Assignee: Arisawa Mfg., Ltd., Niigata (JP)

(21) Appl. No.: 11/338,424

(22) Filed: Jan. 24, 2006

(30) Foreign Application Priority Data
Jan. 31, 2005 (JP) 2005-024248

(51) Int. Cl. G03B 21/60

(52) U.S. Cl. 359/455

(57) ABSTRACT

The lens sheet of the present embodiment comprises a lens portion which is formed on one side of the lens sheet and has a microrelief surface, a substrate which is arranged on the opposite side to the microrelief surface and supports the lens portion, and a buffer layer which is sandwiched between the lens portion and the substrate and has a smaller storage elastic modulus than those of the lens portion and the substrate. The lens portion can be divided into plurality of sub-portions, each of which has a discrete bottom attaching to the buffer layer, and is supported independently by the buffer layer.

### CROSS REFERENCE TO RELATED APPLICATION

The present application claims priority from a Japanese Patent Application No. JP 2005-024248 filed on Jan. 31, 2005, the contents of which are incorporated herein by reference.

### BACKGROUND OF THE INVENTION

1. Field of the Invention

The present invention relates to a lens sheet having a microrelief surface, a light transmitting screen unit including the lens sheet, and a method of manufacturing a lens sheet.

2. Related Art

There is a problem that when a Fresnel lens sheet made of polymer materials contacts another component, the peaks of the microrelief surface forming a lens portion of the Fresnel lens change the shapes. To solve the problem, the lens portion is made of a harder resin so that the peaks of the microrelief surface are easier to keep the shape but more brittle. Some prior art documents disclose some polymer materials to prevent the lens portion from both deformation and breakage. See, for example, Japanese Patent Application Publication No. 2003-84101.

These prior art materials and methods, however, cannot fully satisfy the demand to be free from both such deformation and breakage.

### SUMMARY OF THE INVENTION

To solve the above problem, the first embodiment of the present invention provides a light transmitting lens sheet which comprises; a lens portion formed on one side of the lens sheet and having a microrelief surface; a substrate on the opposite side to the microrelief surface to support the lens portion; and a buffer layer sandwiched between the lens portion and the substrate and having a smaller storage elastic modulus than those of the lens portion and the substrate. When an external force is applied to peaks of the microrelief surface, the buffer layer of the lens sheet can change the shape to distribute the stress. Such lens sheets can be easier to keep the shapes of the peaks of the microrelief surface, which substantially satisfies the demand to be free from both such deformation and breakage of the lens portion.

In the above lens sheet, the lens portion may be divided into a plurality of sub-portions. Each sub-portion has a discrete bottom attaching to and supported by the buffer layer independently. In such lens sheet, each sub-portion of the lens portion can move more freely so that deformation of the peaks of the microrelief surface reduces more.

The lens portion and the buffer layer are made of polymer materials. The glass transition point temperature of the buffer layer may be lower than that of the lens portion. Such lens sheet tens to prevent the lens portion from damages.

The buffer layer of the area around the edges of the lens sheet is thicker than in the central part thereof. Such lens sheet can assure the shape stability of the buffer layer and improve the load following capability of the edges thereof. This allows the peaks of the microrelief surface to reduce the deformation when the lens sheet is applied pressure on the edges thereof to be assembled.

The second embodiment of the present invention provides a light transmitting screen unit which includes; a lens sheet comprising a lens portion formed on one side of the lens sheet and having a microrelief surface, a substrate on the opposite surface to the microrelief surface to support the lens portion, and a buffer layer sandwiched between the lens portion and the substrate and having a smaller storage elastic modulus than those of the lens portion and the substrate; an optical component facing the microrelief surface of the lens sheet and having a larger storage elastic modulus than that of the buffer layer of the lens sheet; and holding means holding and binding the lens sheet and the optical component with the microrelief surface of the lens sheet contacting the optical component. Such light transmitting screen unit can reduce damage at the contact points between the peaks of the microrelief surface of the lens sheet and the optical component.

The third embodiment of the present invention is a method of manufacturing a lens sheet having a microrelief surface which comprises; a buffer layer forming process in which a transparent substrate sheet is prepared and deposited an adhesive on one surface of the substrate to form a buffer layer, the adhesive has a smaller storage elastic modulus in cured state than that of the resin forming the microrelief of the lens portion of the lens sheet; a resin pouring process in which uncured hard UV curable resin having a larger storage elastic modulus in cured state than that of the buffer layer is poured and filled in the cavity of a mold used for molding the microrelief surface of the lens sheet; a pressing process in which the substrate is attached the side laminated the buffer layer to the hard UV curable resin and pressed down against the mold; a resin curing process after the pressing process in which the hard UV curable resin is cured by irradiation of UV light through the substrate; and a mold releasing process in which the lamination of the substrate, the buffer layer, and the lens portion having microrelief surface is separated from the mold. According to such method, the lens sheet without damaging the peaks of the microrelief surface which is made of hard UV curable resin can be manufactured efficiently.

In the above manufacturing method, the buffer layer forming process may include a process in which an adhesive is deposited on one surface of the substrate including the central part of the lens sheet, and a process in which the adhesive is further deposited on around the edges of the lens sheet. The total adhesive deposited around the edges of the lens sheet is thicker than that deposited in the central part thereof. This can efficiently manufacture the lens sheet assuring the shape stability of the buffer layer in the central part of the lens sheet, and also improving the load following capability around edges of the microrelief surface of the lens sheet.

The above summary of the present invention doesn't include all of the necessary features. The sub-combinations of these features may be inventions.

### BRIEF DESCRIPTION OF THE DRAWINGS

FIG. 1 shows a structure of a rear projection display device 800 related to the present invention.

FIG. 2 is a partially enlarged view of the A area (shown in FIG. 1) of the screen unit 500.

FIG. 3 is a plan view of the Fresnel lens sheet 200.

FIG. 4 is a sectional view of the Fresnel lens sheet 200.

FIG. 5 is a partially sectional view of the structure of the Fresnel lens sheet 200 of the first embodiment.

FIG. 6 is a partially sectional view of the structure of the Fresnel lens sheet 200 of the second embodiment.

FIG. 7 is a partially sectional view of the structure of the Fresnel lens sheet 200 of the third embodiment.

FIG. 8 shows an example process of the method of manufacturing the Fresnel lens sheet 200.

FIG. 9 shows an example process of the method of manufacturing the Fresnel lens sheet 200.

FIG. 10 shows an example process of the method of manufacturing the Fresnel lens sheet 200.

FIG. 11 shows an example process of the method of manufacturing the Fresnel lens sheet 200.

FIG. 12 shows an example process of the method of manufacturing the Fresnel lens sheet 200.

FIG. 13 shows an example process of the method of manufacturing the Fresnel lens sheet 200.

FIG. 14 shows an example process of the method of manufacturing the Fresnel lens sheet 200.

FIG. 15 explains how to test the effect of the buffer layer 22.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

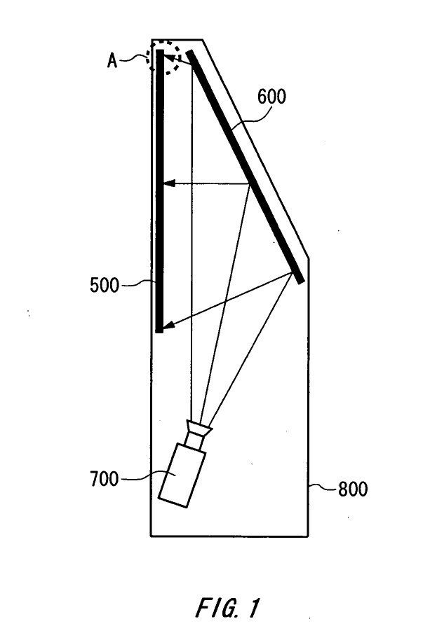

FIG. 1 shows a structure of the rear projection display device 800 related to the present embodiment. The rear projection display device 800 includes a projection unit 700, a mirror 600, and a screen unit 500. An optical image emitted from the projection unit 700 is reflected on the mirror 600, and reached the screen unit 500. The screen unit 500 transmits and spreads the optical image toward viewers who are in the viewable zone.

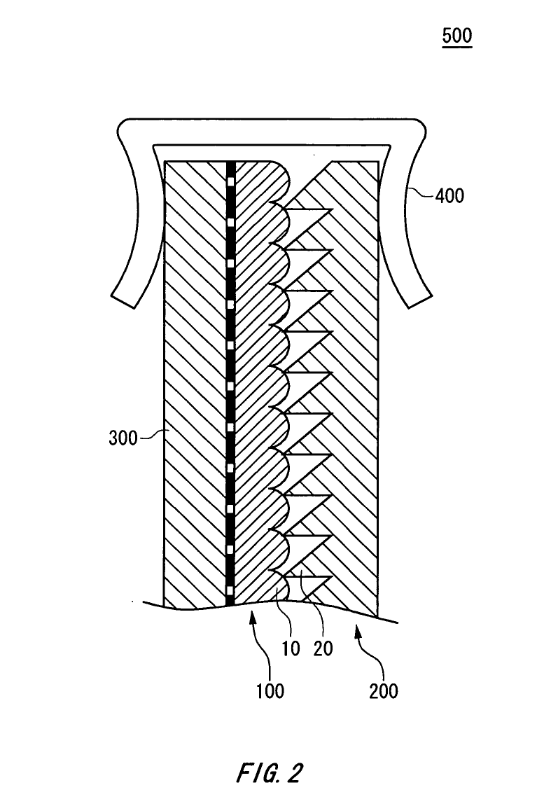

FIG. 2 shows the details of the A area (shown in FIG. 1) of the screen unit 500. The screen unit 500 comprises a Fresnel lens sheet 200, a lenticular lens sheet 100, and an outermost optical sheet 300, each of which is parallel to, and adjacent to or close to each other. The Fresnel lens sheet 200 has a plurality of prisms 20 to collimate the light, which is emitted from the projection unit 700, in the approximately perpendicular direction to the screen unit 500. The lenticular lens sheet 100 has a plurality of single hemicylindrical lenses 10 to pass out and diffuse the incident light. The outermost optical sheet 300 protects the lenticular lens sheet 100, and prevents from reflecting outside light on the outside surface thereof which is treated with an anti-glare (AG) coating or an anti-reflection (AR) coating. The prism 20 and the single lens 10 are example elements making up the microrelief structures on the surface of the lens portion. The lenticular lens sheet 100 may be a fly-eye lens sheet.

Holding means 400 bind the Fresnel lens sheet 200, the lenticular lens sheet 100, and the outermost optical sheet 300 on the edges thereof. The prisms 20 of the Fresnel lens sheet 200 face the single lenses 10 of the lenticular lens 100. The holding means 400 are arranged at four points around the edges of the screen unit 500. The holding means 400 are made of metal or resin to give grip force to the same. The screen unit 500 is an example of the light transmitting screen unit of the present invention. The lenticular lens sheet 100 and the Fresnel lens sheet 200 are examples of the lens sheet of the present invention. If the lenticular lens sheet 100 is considered as the present lens sheet, the Fresnel lens sheet 200 will be the present optical component. Alternatively, if the Fresnel lens sheet 200 is considered as the present lens sheet, the lenticular lens sheet 100 will be the present optical component. The lens sheet may be a fly-eye lens sheet having plurality of single dome lenses. In that case, the single dome lens is an example of the sub-portion making up the microrelief surface of the lens portion. The optical component facing the lens sheet is, for example, a fly-eye lens sheet, a lenticular lens sheet, a diffuser, a polarizer, or a retarder which is used as required by the application of the screen unit 500.

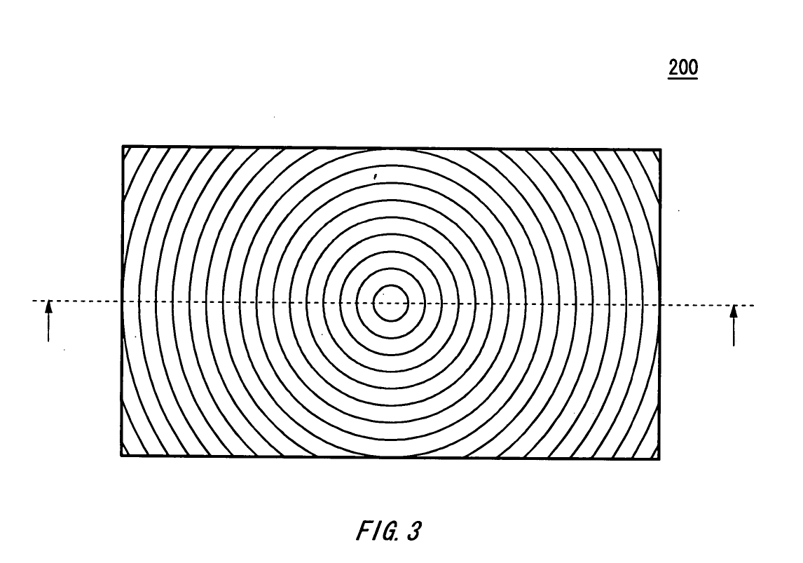

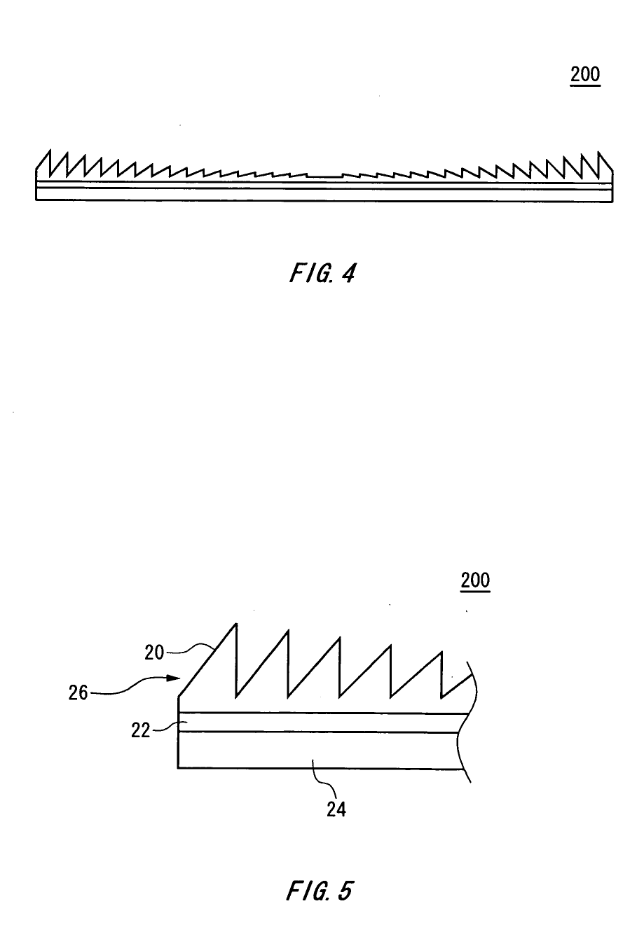

FIG. 3 is a plan view showing the Fresnel lens sheet 200. FIG. 4 shows a sectional view of the Fresnel lens sheet 200. The Fresnel lens sheet 200 has the prisms 20 aligned concentrically with no space between one another. The Fresnel lens sheet 200 has the aspect ratio required by the application thereof. For example, when the Fresnel lens sheet 200 is used for the rear projection display device 800, the aspect ratio of the longitudinal direction to the transverse direction thereof in FIG. 3 is approximately 16:9. Another example of the aspect ratio is approximately 4:3. The height of the outer adjacent prism is larger than that of the inner adjacent prism, as shown in FIG. 4.

FIG. 5 is a sectional view showing a laminated structure of the first embodiment of the Fresnel lens sheet 200. The Fresnel lens sheet 200 comprises a substrate 24, a lens portion 26, and a buffer layer 22. Both of the lens portion 26 and the buffer layer 22 are made of transparent polymer materials. The lens portion 26 is, for example, made of UV curable urethan acrylate. The buffer layer 22 is made acrylic adhesive which cannot be cured by UV light. The substrate 24 is made of either transparent polymer materials or transparent glass. The lens portion 26 is formed on one side of the Fresnel lens sheet 200 and has plurality of the prisms 20. The substrate 24 is arranged on the opposite side to the plurality of the prisms 20 to support the lens portion 26. The buffer layer 22 is arranged between the lens portion 26 and the substrate 24, and has a smaller storage elastic modulus than those of the lens portion 26 and the substrate 24. Such laminated structure allows the buffer layer 22 to distribute the stress and change the shape thereof when an external force is applied to the peaks of the prisms 20. This can be easier to keep the shapes of the peaks of the microrelief surface, which substantially satisfies the demand to be free from both such deformation and breakage of the lens portion.

The following describes how to measure each storage elastic modulus of the polymer material constituting the buffer layer 22 and the lens portion 26. Equipment: Dynamic Mechanical Analysis (DMA) Method: tension test Programming rate: 3° C./minute Testing speed: 1 Hz Measured temperature range: −20 to 80° C. Readout method: readout the storage elastic modulus (E′) at each temperature

In the structure shown in FIG. 2, the storage elastic modulus of the single lens 10 facing the lens portion 26 is equal to or more than that of the buffer layer 22. In other words, the glass transition point temperature of the buffer layer 22 is equal to or less than that of the single lens 10. Such relationships in storage elastic modulus and glass transition point temperature can prevent the single lens 10 and/or the lens portion 26 from damaging due to the buffering effect of the buffer layer 22 when they contact each other in assembling into the screen unit 500 or in transportation.

The glass transition point temperature of the buffer layer 22 is less than that of the lens portion 26. The storage elastic modulus of the buffer layer 22 is also less than that of the lenticular lens sheet 100. This allows the single lenses 10 and the prisms 20 to prevent from damaging when the lenticular lens sheet 100 and the Fresnel lens sheet 200 are bound by the holding means 400 with the single lens 10 of the lenticular lens sheet 100 and the prisms 20 of the Fresnel lens sheet 200 facing each other, as shown in FIG. 2.

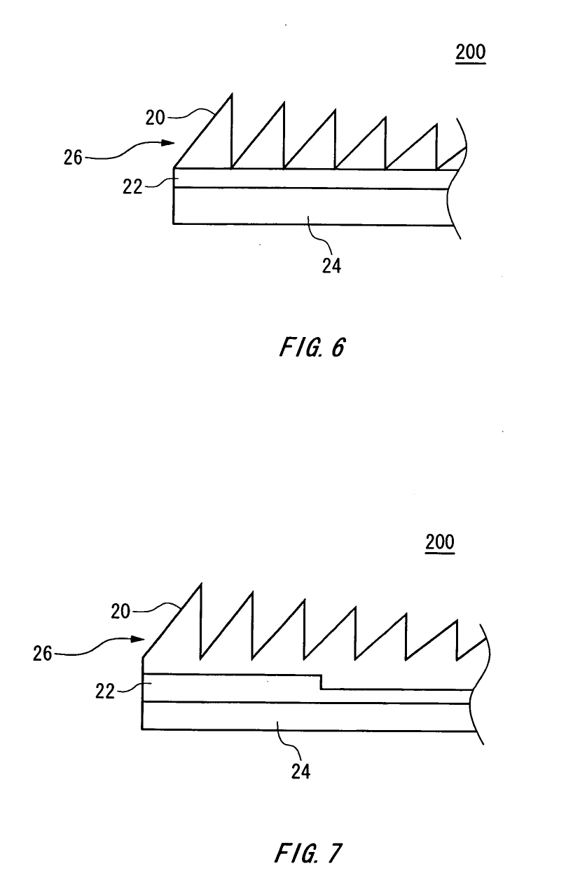

The lens portion 26 on one surface of the buffer layer 22 may be divided into plurality of sub-portions. Each sub-portion may be supported by the buffer layer 22 independently. In such case, each sub-portion of the lens portion can move more freely so that deformation of the peaks of the microrelief surface reduces more. An example of this type of the lens portion 26 is shown in FIG. 6.

FIG. 6 shows the second embodiment of the Fresnel lens sheet 200. The second embodiment is different from the first one in that each prism 20 of the lens portion 26 is supported by the buffer layer 22 independently. Except for that, the second embodiment is the same as the first one, so the same description can be omitted. Each prism 20 has a discrete bottom attaching to the buffer layer 22, and is separated from the adjacent prism. With such structure, the prism 20 can sink into the buffer layer independently of the adjacent prisms. The lens portion 26 having such prisms 20, therefore, improves the load following capability thereof when an external force is applied to a part of the prisms 20. The deformation of the peaks of the prisms 20 can be further reduced.

FIG. 7 shows the third embodiment of the Fresnel lens sheet 200. The third embodiment is different from the first one in that the buffer layer 22 around the edges of the Fresnel lens sheet 200 is thicker than in the central part thereof. Except for that, the third embodiment is the same as the first embodiment, so the same description can be omitted. Such structure of the present embodiment can assure the shape stability in the central part of the Fresnel lens sheet 200, and improve the load following capability around the edges of the lens portion 26. The deformation of the peaks of the prisms 20 can be further reduced when the edges of the Fresnel lens sheet 200 is pressed to be assembled.

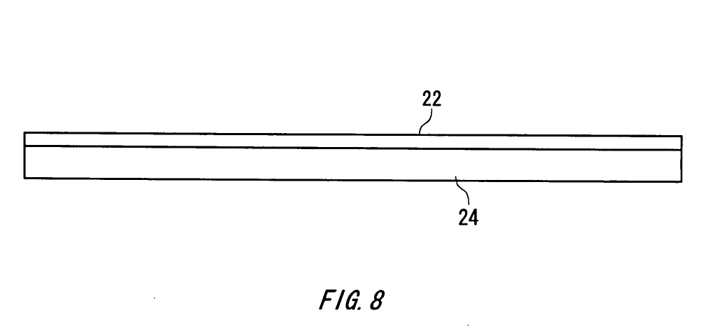

FIGS. 8 through 12 show the first embodiment of the method of manufacturing the Fresnel lens sheet 200. According to the present embodiment, the method of manufacturing the Fresnel lens sheet 200 includes a buffer layer forming process, a resin pouring process, a pressing process, a resin curing process, and a mold releasing process.

FIG. 8 shows the buffer layer forming process of the present embodiment. In the buffer layer forming process, the buffer layer 22 is formed with an even thickness on one surface of the substrate 24. A transparent resin plate is used as the substrate 24. The resin plate is larger than the product of the Fresnel lens sheet 200. The substrate 24 is made of transparent resin of styrene series such as methacryl styrene (MS), polycarbonate, and polyethylene terephthalate (PET).

The buffer layer 22 may be made of an adhesive sheet made of transparent acrylic adhesive. Such buffer layer 22 isn't cured by UV light. The buffer layer 22 may also be made of transparent UV curable adhesive such as urethan acrylate. When the UV curable adhesive is used for the buffer layer 22, an uncured UV curable adhesive is deposited in the buffer layer forming process, and is cured to be the buffer layer 22 in the next curing process. The buffer layer 22 has the properties below; Storage elastic modulus (E′): 0.01 to 1 MPa (15° C. to 40° C.) Loss tangent (Tanδ): 0.5 or less (15° C. to 40° C., 1 Hz, measured at each temperature) Glass transition point temperature (Tg): −70° C. to 0° C.

The relation between these properties can be expressed in the following equation. Tanδ=E″/E′ (E′: storage elastic modulus; E″: loss modulus) Values of Tanδ show how easy to restore and suffer damage for resin. The larger Tanδ indicates that the used resin is easier to restore and more resistant to damage. Tg is the temperature at which the Tanδ marks the largest value, and indicates the hardness of the resin.

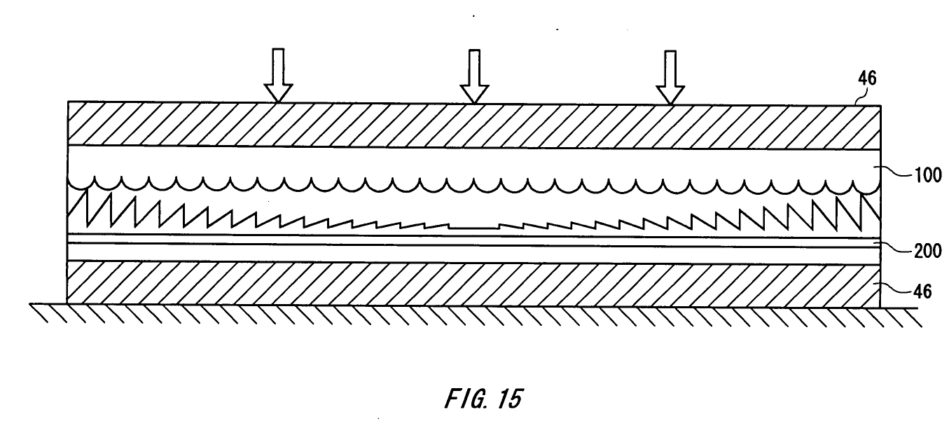

There are two ways to reduce the storage elastic modulus of acrylic adhesive of the buffer layer 22; decreasing the crosslink density in the buffer layer 22; and using the material having a low glass transition point temperature. To decrease the crosslink density in the buffer layer 22, for example, copolymer of acrylate series monomer having functional groups such as carboxyl group is used as the base resin. The amount of the functional group is no more than 5%, preferably no more than 1%, of the total amount of monomer. If the material having a low Tg is used, 2-ethylhexyl acrylate series is used as the base resin, for example, the copolymer of acrylate series monomer having functional groups such as carboxyl group. The amount of the monomer having such functional group is no more than 5%, preferably no more than 1%, of the total amount of the monomer. If the material having a low Tg is used, the copolymer which is copolymerized 2-ethylhexyl acrylate is used. For a cross-linker, the compound of tolylenediisocyanate series or hexamethylene diisocyanate series is used. The compound is blended in the amount of 1% or less of the solid content of the above copolymer, which produces the acrylic adhesive having a lower storage elastic modulus. If the storage elastic modulus of the buffer layer 22 decreases, the prisms 20 can be more resistant to damage, though the buffer layer 22 of the Fresnel lens sheet 200 reduces the shape stability thereof. The storage elastic modulus of the buffer layer 22 is adjusted, so that the damage resistance of the prism 20 and the shape stability of the buffer layer 22 should be balanced. The method of defining the damage resistance of the prism 20 quantitatively is described later with referring to FIG. 15.

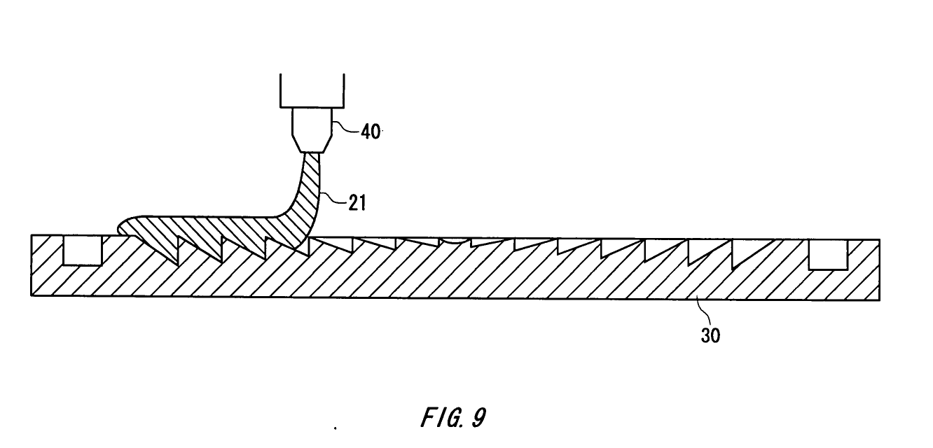

FIG. 9 shows the resin pouring process of the present embodiment. In the resin pouring process, the uncured resin for lens portion 21 is poured with a dispenser 40, and filled in the cavity of the mold 30 which forms and molds the plurality of the prisms 20. The uncured resin for lens portion 21 is an example of the UV curable resin whose storage elastic modulus in cured state is higher than that of the buffer layer 22. The uncured resin for lens portion 21 is, for example, transparent UV curable resin, or 2P resin, such as urethan acrylate resin. The uncured resin for lens portion 21 of the present embodiment is highly viscous fluid. If the urethan acrylate resin is used for the uncured resin for lens portion 21, it is required having the following properties. The measurement condition is the same as the buffer layer 22. Storage elastic modulus (E′): 5 to 2000 MPa (15° C. to 40° C.) Loss tangent (Tanδ): 0.01 to 1.2 (15° C. to 40° C., 1 Hz, at each temperature) Glass transition point temperature (Tg): 15° C. to 60° C.

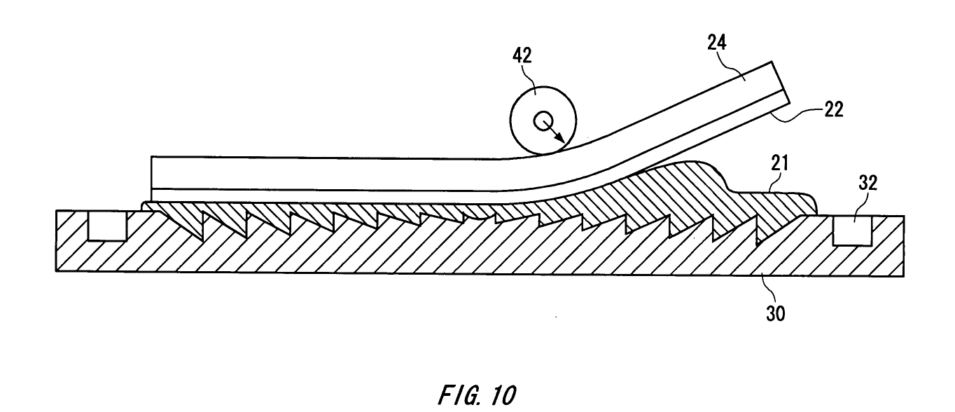

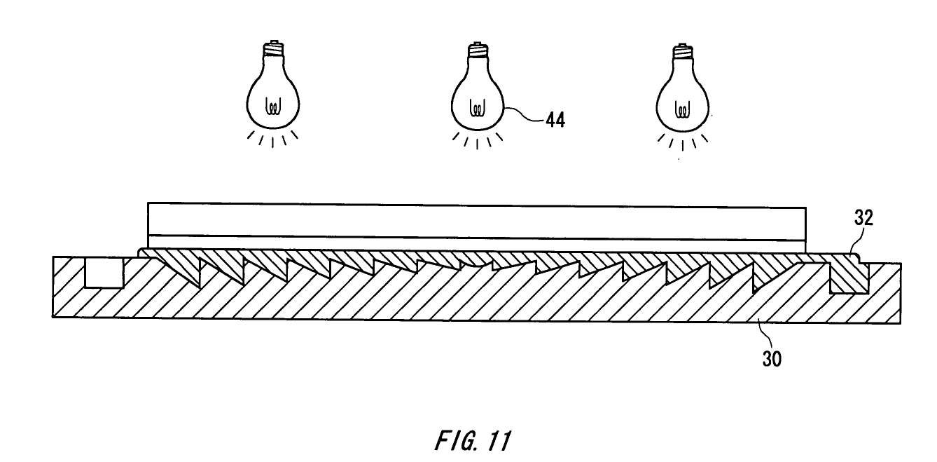

FIG. 10 shows the pressing process of the present embodiment. In the pressing process, the substrate 24 is attached the side laminated the buffer layer 22 to the uncured resin for lens portion 21 and pressed down against the mold 30. A roller 42 is moved across the substrate 24. The roller is adjusted the height to press down on the substrate so that the distance from the virtual plane on top of the prisms 20 of the mold 30 to the upper surface of the glass substrate 24 is equal to the required height from the bottom of the prism 20 of the Fresnel lens sheet 200 to the open-air surface of the glass substrate 24. The pressing process is operated in a vacuum chamber to reduce the pressure around the mold 30. This allows the uncured resin for lens portion 21 to prevent from trapping air and to be filled in the mold cavity of the mold 30. A trench 32 is formed around the cavity for molding the prisms 20 in the mold 30. The trench 32 dams the uncured resin for lens portion 21 flowing over the edges of the substrate 24.

FIG. 11 shows the resin curing process of the present embodiment. The resin curing process is operated at atmosphere pressure. In the resin curing process following to the pressing process, the uncured resin for lens portion 21 is cured by irradiation of UV light through the glass substrate 24. UV lumps 44 are used for the UV irradiation. The UV lumps 44 set above the glass substrate 24 irradiate UV light for enough time to solidify the uncured resin for lens portion 21. The cured resin for lens portion 21 forms the lens portion 26. If the UV curable adhesive is used for the buffer layer 22, before the pressing process shown in FIG. 10 and in the buffer layer forming process, the uncured UV curable adhesive laminated on the substrate 24 may be cured by irradiation of UV light. In such case, the UV curable adhesive has been already cured in the pressing process and formed the buffer layer 22. This allows the buffer layer 22 to maintain the shape stably when it is pressed down in the pressing process.

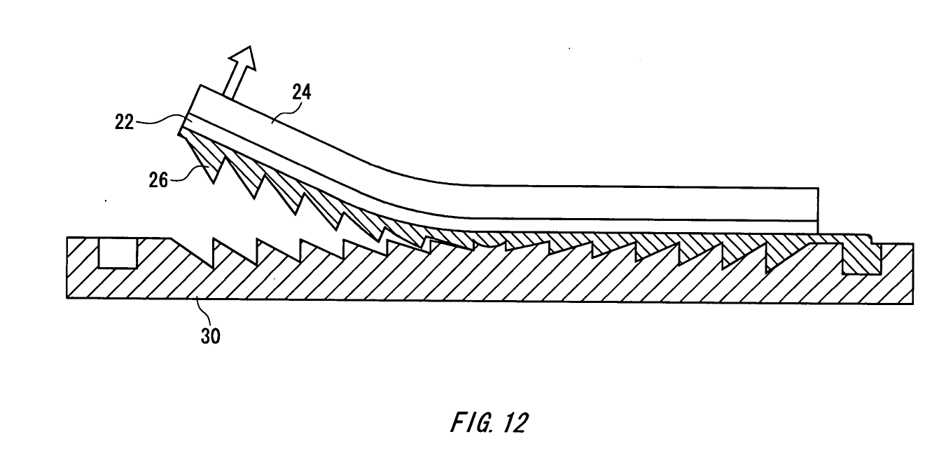

FIG. 12 shows the mold releasing process of the present embodiment. In the mold releasing process, the mold 30 is released from the lamination of the glass substrate 24, the buffer layer 22, and the lens portion 26. One edge of the substrate 24 is picked and pulled up to the opposite edge thereof as bending the body thereof. After releasing the mold 30, the lamination is cut out in the required size for the screen unit 500 to be provided as the Fresnel lens 200. According to the above method, the Fresnel lens sheet 200 can be produced, in which the peaks of the prisms 20 made of hard UV curable resin tend to be less deformed.

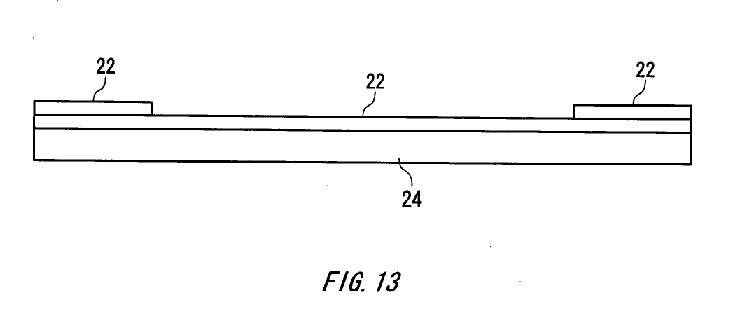

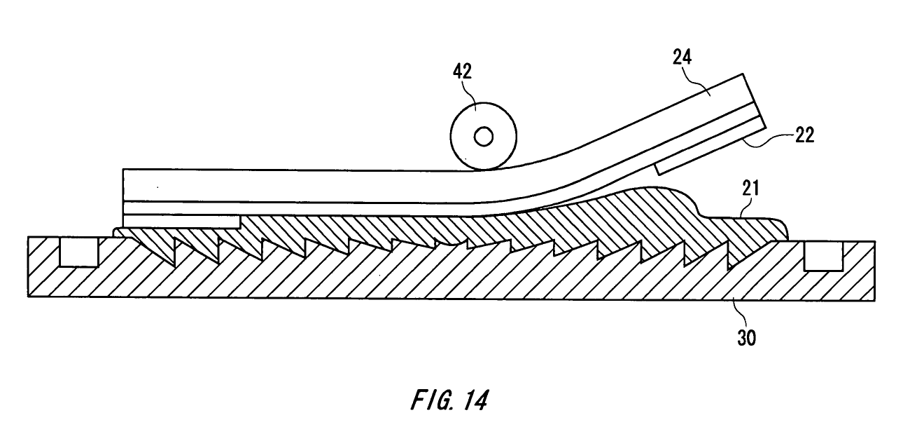

FIGS. 13 and 14 show the second embodiment of the method of manufacturing the Fresnel lens sheet 200. According to the present embodiment, the third embodiment of the Fresnel lens sheet 200 shown in FIG. 7 can be manufactured. The method of manufacturing the Fresnel lens sheet 200 related to the present embodiment comprises a buffer layer forming process, a resin pouring process, a pressing process, a resin curing process, and a mold releasing process. The buffer layer forming process and the pressing process are different from the former embodiment.

FIG. 13 shows the buffer layer forming process of the present embodiment. The buffer layer forming process includes a process in which acrylic adhesive is deposited on the area of the substrate 24 including the central part of the Fresnel lens sheet 200 to form the buffer layer 22 with an even thickness, and a process in which the adhesive is deposited on the area including the edges of the Fresnel lens sheet 200 with a larger thickness than that of the central part thereof. For example, an adhesive sheet is laminated on the whole surface of the substrate with the even thickness to form the buffer layer 22. After that, the adhesive is further deposited on the area including the edges of the Fresnel lens sheet 200. The resin pouring process is the same as the counterpart of the first embodiment shown in FIG. 9. The description is omitted.

FIG. 14 shows the pressing process of the present embodiment. In the pressing process, the substrate 24 laminated the buffer layer 22 whose thickness in the area including the edges of the Fresnel lens sheet 20 is larger than that of the central part is pressed against the mold 30 in the same way of the pressing process of the first embodiment shown in FIG. 10. The rest processes are the same as the resin curing process shown in FIG. 11 and the mold releasing process shown in FIG. 12. The descriptions are omitted. According to the manufacturing method of the present embodiment, the Fresnel lens sheet 200 can be manufactured efficiently, in which the buffer layer 22 around the edges of the Fresnel lens sheet 200 is thicker than in the central part thereof. The Fresnel lens sheet 200 which maintains the shape stability and improve the load following capability of the prisms 20 around the edges can be also manufactured efficiently.

FIG. 15 shows how to define the effect of the buffer layer 22 quantitatively. In the present embodiment, the Fresnel lens sheet 200 and the lenticular lens 100 are contacted each other with the prisms 20 of the Fresnel lens sheet 200 facing to the single lenses 10 of the lenticular lens sheet 100, and sandwiched between two glass plates 46 to keep the whole of them horizontal. Then the load is applied downwardly on the upper glass plate 46. It is preferable that the glass plates 46 are assured to be parallel to each other, and applied load evenly over the plates 46. For example, a weight is put on each corner of the upper glass plate 46 so that the whole set of the lenticular lens sheet 100 and the Fresnel lens sheet 200 is pressed evenly. As gradually increasing the load applied on the glass plate 46, the force applied by the lenticular lens sheet 100 to the prisms 20 of the Fresnel lens sheet 200 increases, which causes the apparent deformation of the peaks of prisms 20. To define quantitatively the resistance against external force of the peaks of the prisms 20, the minimum load with which the deformation of the tops of the prisms 20 is checked with eyes at first is measured.

To decide the thickness and the storage elastic modulus of the buffer layer 22 of the Fresnel lens sheet 200, several samples with various combinations of the values of the two properties are prepared to be selected one or a few which balance the shape stability of the buffer layer 22 and the damage resistance of the prism 20. On this measurement, the Fresnel lens sheet 200 is faced the optical component which is actually assembled with the Fresnel lens sheet 200 into the screen unit 500. A fly-eye lens sheet, a diffuser, a polarizer, or a retarder may be used as well as the lenticular lens sheet 100 of the present embodiment.

Apparent from the above description, according to the present embodiment, when an external force is applied to the peaks of the microrelief surface of the lens portion of the lens sheet, the buffer layer thereon changes the shape to distribute stress. Such lens sheets can be easier to keep the shapes of the peaks of the microrelief surface, which substantially satisfies the demand to be free from both such deformation and breakage of the lens portion.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A light transmitting lens sheet comprising;
a lens portion formed on one side of said lens sheet and has a microrelief surface;
a substrate arranged on the opposite side to said microrelief surface to support said lens portion; and
a buffer layer sandwiched between said lens portion and said substrate, said buffer layer having a smaller storage elastic modulus than those of said lens portion and said substrate.

2. The lens sheet according to claim 1 wherein said microrelief surface of said lens portion is divided into plurality of sub-portions which has a discrete bottom attached to said buffer layer, and each said sub-portion is independently supported by said buffer layer.

3. The lens sheet according to claim 1 wherein said lens portion and said buffer layer are made of polymer materials, and the glass transition temperature of said buffer layer is lower than that of said lens portion.

4. The lens sheet according to claim 1 wherein said buffer layer around edges of the lens sheet is thicker than the central part of the lens sheet.

5. A light transmitting screen comprising;
a lens sheet which comprise;
a lens portion formed on one surface of said lens sheet and has a microrelief surface;
a substrate arranged on the opposite side to said microrelief surface to support said lens portion; and
a buffer layer sandwiched between said lens portion and said substrate and has a smaller storage elastic modulus than those of said lens portion and said substrate;
an optical component facing said microrelief surface of said lens portion, said optical component having a larger storage elastic modulus than said buffer layer; and
holding means for holding and binding said lens sheet and said optical component with said microrelief surface of said lens sheet facing said optical component.

6. A method of manufacturing a resin lens sheet having a microrelief surface comprising:
a buffer layer forming step in which a transparent adhesive is deposited on a surface of transparent substrate sheet to form a buffer layer, the transparent adhesive having a smaller storage elastic modulus than the resin making up said microrelief surface;
a resin pouring step in which an uncured hard UV curable resin having a larger storage elastic modulus in cured state than that of said buffer layer is poured and filled in the cavity of a mold used for molding said microrelief surface;
a pressing step in which said substrate is attached the side laminated said buffer layer to said uncured UV curable resin for lens portion and pressed down against said mold;
a resin curing step in which said hard UV curable resin is cured by irradiation of UV light through said substrate after said pressing process; and
a mold releasing step in which said mold is released from the lamination of said substrate, said buffer layer, and the cured layer of said microrelief surface made of said hard UV curable resin.

7. The method of manufacturing a lens sheet according to claim 6 wherein said buffer layer forming process further includes a process in which said adhesive is deposited on the area of one surface of said substrate including the central part of said lens sheet, and a process in which said adhesive is further deposited on the area including the edges of the lens sheet, where the thickness of said adhesive is larger than that of the central part.
